(19) United States
(12) Patent Application Publication
(10) Pub. No.: US 2022/0354041 A1
(43) Pub. Date: Nov. 10, 2022

(54) DISC ASSEMBLY FOR AN AGRICULTURAL IMPLEMENT

(71) Applicant: CNH Industrial America LLC, New Holland, PA (US)

(72) Inventors: Timothy Richard Blunier, Danvers, IL (US); Christopher Aaron Lursen, Shell Rock, IA (US); John Clark Endsley, Washington, IL (US); Michael George Kovach, Morton, IL (US)

(73) Assignee: CNH Industrial America LLC

(21) Appl. No.: 17/315,882

(22) Filed: May 10, 2021

(51) Int. Cl. A01B 15/16; F16D 1/08

(52) U.S. Cl. CPC A01B 15/16; F16D 1/0876

(57) ABSTRACT

A disc assembly for an agricultural implement includes a mounting assembly having a housing and a rotatable shaft disposed within the housing. The rotatable shaft includes a recess extending along a portion of an axial extent of the rotatable shaft. The recess is formed by an inner surface of the rotatable shaft. The rotatable shaft also includes a first engagement feature formed on the inner surface and a key disposed about the recess. The key is configured to engage an opening of a disc blade to block rotation of the disc blade relative to the rotatable shaft. Furthermore, the disc assembly includes a fastener having a shaft configured to extend through the opening of the disc blade and to engage the recess of the rotatable shaft. The shaft has a second engagement feature configured to engage the first engagement feature to couple the disc blade to the rotatable shaft.

### BACKGROUND

The present disclosure relates generally to a disc assembly for an agricultural implement.

Certain agricultural implements include ground engaging tools configured to interact with soil. For example, a tillage implement may include tillage points and disc blades configured to break up the soil for subsequent planting or seeding operations. Each disc blade may be individually mounted to a respective mounting assembly that facilitates rotation of the disc blade. Each mounting assembly may include a shaft configured to rotate within a bearing assembly, and a hub may be coupled to an end of the shaft. The disc blade may couple to the hub via multiple fasteners, such as four to six bolts. Accordingly, the process of replacing each disc blade includes disengaging each fastener (e.g., separating a bolt and nut from one another), removing and replacing the disc blade, and reengaging each fastener. As a result, the process of replacing disc blades may be significantly time-consuming, thereby reducing the efficiency of agricultural (e.g., tillage) operations.

### BRIEF DESCRIPTION

In certain embodiments, a disc assembly for an agricultural implement includes a mounting assembly having a housing and a rotatable shaft disposed within the housing. The rotatable shaft is configured to rotate relative to the housing, and the rotatable shaft includes a recess extending along a portion of an axial extent of the rotatable shaft. The recess is formed by an inner surface of the rotatable shaft. The rotatable shaft also includes a first engagement feature formed on the inner surface and a key disposed about the recess. The key is configured to engage an opening of a disc blade to block rotation of the disc blade relative to the rotatable shaft. In addition, the disc assembly includes a fastener having a shaft configured to extend through the opening of the disc blade and to engage the recess of the rotatable shaft. The shaft of the fastener has a second engagement feature configured to engage the first engagement feature to couple the disc blade to the rotatable shaft.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural implement having disc assemblies;

FIG. 2 is a perspective view of an embodiment of a disc assembly that may be employed within the agricultural implement of FIG. 1;

FIG. 3 is an exploded view of the disc assembly of FIG. 2;

FIG. 4 is a cross-sectional view of the disc assembly of FIG. 2; and

FIG. 5 is a cross-sectional view of a portion of another embodiment of a disc assembly that may be employed within the agricultural implement of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

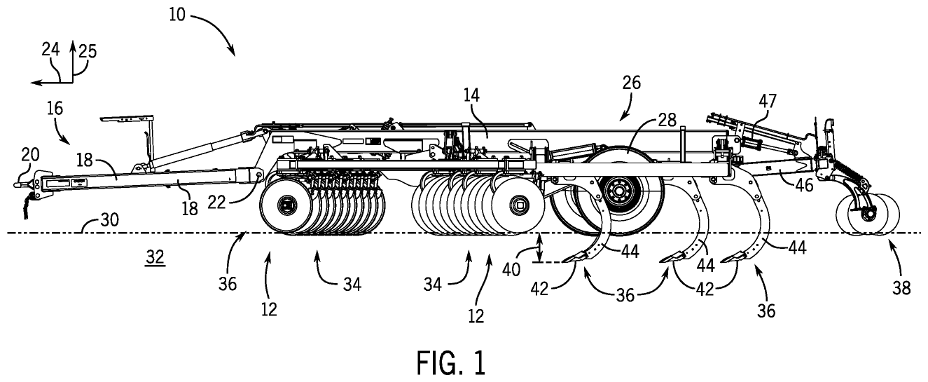

FIG. 1 is a side view of an embodiment of an agricultural implement 10 having disc assemblies 12. In the illustrated embodiment, the agricultural implement 10 is a primary tillage implement having multiple ground engaging tools configured to till soil. As illustrated, the agricultural implement 10 includes a frame 14 and a hitch assembly 16 coupled to the frame 14. In certain embodiments, the frame 14 is substantially rigid (e.g., does not include any translatable and/or rotatable components). However, in other embodiments, the frame may include one or more translatable and/or rotatable components. Furthermore, the frame 14 may be formed from multiple frame elements (e.g., rails, tubes, braces, etc.) coupled to one another (e.g., via welded connection(s), via fastener(s), etc.). The hitch assembly 16 includes a hitch frame 18 and a hitch 20. The hitch frame 18 is pivotally coupled to the implement frame 14 via pivot joint(s) 22, and the hitch 20 is configured to couple to a corresponding hitch of a work vehicle (e.g., tractor), which is configured to tow the agricultural implement 10 through a field along a direction of travel 24. While the hitch frame 18 is pivotally coupled to the implement frame 14 in the illustrated embodiment, in other embodiments, the hitch frame may be movably coupled to the implement frame by a linkage assembly (e.g., four bar linkage assembly, etc.) or another suitable assembly/mechanism that enables the hitch to move along a vertical axis 25 relative to the implement frame.

As illustrated, the agricultural implement 10 includes wheel assemblies 26 movably coupled to the implement frame 14. In the illustrated embodiment, each wheel assembly 26 includes a wheel frame and a wheel 28 rotatably coupled to the wheel frame. The wheels 28 of the wheel assemblies 26 are configured to engage the surface 30 of the soil 32, and the wheel assemblies 26 are configured to support at least a portion of the weight of the agricultural implement 10. In the illustrated embodiment, each wheel frame is pivotally coupled to the implement frame 14, thereby facilitating adjustment of the position of each wheel 28 along the vertical axis 25. However, in other embodiments, at least one wheel frame may be movably coupled to the implement frame by another suitable connection (e.g., sliding connection, linkage assembly, etc.) that facilitates adjustment of the vertical position of the respective wheel(s).

In the illustrated embodiment, the agricultural implement 10 includes ground engaging tools, such as the illustrated disc blades 34 of the disc assemblies 12, tillage point assemblies 36, and finishing discs 38. The disc blades 34 are configured to engage a top layer of the soil 32. As the agricultural implement 10 is towed through the field, the disc blades 34 are driven to rotate, thereby breaking up the top layer. In the illustrated embodiment, the disc blades 34 are arranged in two rows. However, in alternative embodiments, the disc blades may be arranged in more or fewer rows (e.g., 1, 2, 3, 4, 5, 6, or more). In addition, the angle of each row relative to the direction of travel 24 may be selected to control the interaction of the disc blades 34 with the top layer of soil 32. The tillage point assemblies 36 are configured to engage the soil 32 at a greater depth 40, thereby breaking up a lower layer of the soil. Each tillage point assembly 36 includes a tillage point 42 and a shank 44. The shank 44 is configured to position the tillage point 42 at the depth 40 beneath the soil surface 30, and the tillage point 42 is configured to break up the soil. The shape of each tillage point 42, the arrangement of the tillage point assemblies 36, and the number of tillage point assemblies 36 may be selected to control tillage within the field. Furthermore, as the agricultural implement 10 is towed through the field, the finishing discs 38 are driven to rotate, thereby sizing soil clods, leveling the soil surface, smoothing the soil surface, cutting residue on the soil surface, or a combination thereof.

In the illustrated embodiment, the finishing discs 38 are rotatably coupled to a finishing disc frame 46, and the finishing disc frame 46 is pivotally coupled to the implement frame 14. In addition, biasing member(s) 47 extend between the implement frame 14 and the finishing disc frame 46. The biasing member(s) 47 are configured to urge the finishing disc frame 46 toward the surface 30 of the soil 32, thereby driving the finishing discs 38 to engage the soil. While the finishing disc frame is pivotally coupled to the implement frame in the illustrated embodiment, in other embodiments, the finishing disc frame may be movably coupled to the implement frame by a linkage assembly (e.g., four bar linkage assembly, etc.) or another suitable assembly/mechanism that enables the finishing disc frame to move vertically relative to the implement frame. Furthermore, in certain embodiments, the finishing disc frame may be non-translatably and/or non-rotatably coupled to the implement frame, or the finishing disc frame may be omitted, and the finishing discs may be coupled to the implement frame.

While the illustrated agricultural implement includes the disc blades 34, the tillage point assemblies 36, and the finishing discs 38, in other embodiments, the agricultural implement may include other and/or additional ground engaging tool(s). For example, the tillage point assemblies and/or the finishing discs may be omitted in certain embodiments. Furthermore, in certain embodiments, the agricultural implement may include one or more other suitable ground engaging tools, such as coulter(s), opener(s), and tine(s), among other suitable ground engaging tools. Furthermore, while the agricultural implement 10 is a primary tillage implement in the illustrated embodiment, in other embodiments, the agricultural implement may be a vertical tillage implement, another suitable type of tillage implement, a seeding implement, a planting implement, or another suitable type of implement.

As discussed in detail below, in certain embodiments, at least one disc assembly 12 (e.g., all disc assemblies 12 of the agricultural implement 10, a portion of the disc assemblies 12 of the agricultural implement, etc.) includes a disc blade, a mounting assembly, and a fastener. The disc blade has an opening. In addition, the mounting assembly includes a housing and a rotatable shaft disposed within the housing, in which the rotatable shaft is configured to rotate relative to the housing. Furthermore, the rotatable shaft includes a recess extending along a portion of an axial extent of the rotatable shaft, in which the recess is formed by an inner surface of the rotatable shaft. The rotatable shaft also includes a first engagement feature formed on the inner surface, and the rotatable shaft includes a key disposed about the recess. The key is configured to engage the opening of the disc blade to block rotation of the disc blade relative to the rotatable shaft. In addition, the fastener has a shaft configured to extend through the opening of the disc blade and to engage the recess of the rotatable shaft. The shaft of the fastener also includes a second engagement feature configured to engage the first engagement feature of the rotatable shaft to couple the disc blade to the rotatable shaft. Because the disc blade is coupled to the mounting assembly with a single fastener, the process of replacing the disc blade may be performed significantly faster than replacing a disc blade that is coupled to a mounting assembly with multiple fasteners disposed about an axis of rotation of the disc blade, thereby increasing the efficiency of agricultural (e.g., tillage) operations.

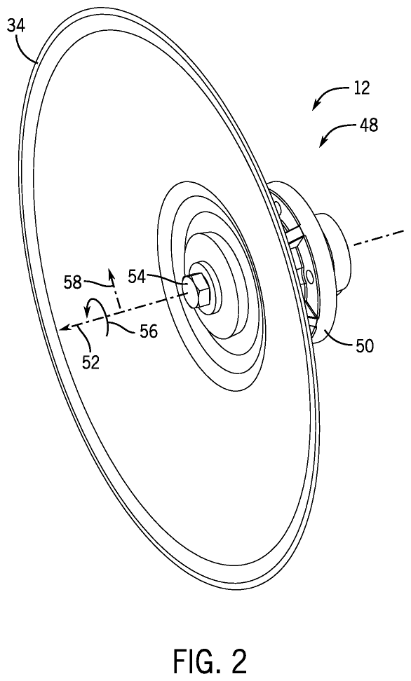

FIG. 2 is a perspective view of an embodiment of a disc assembly 12 that may be employed within the agricultural implement of FIG. 1. In the illustrated embodiment, the disc assembly 12 includes a disc blade 34 having an opening. In addition, the disc assembly 12 includes a mounting assembly 48 having a housing 50 and a rotatable shaft disposed within the housing 50. The rotatable shaft is configured to rotate within the housing 50. For example, in certain embodiments, the mounting assembly may include a bearing assembly disposed between the rotatable shaft and the housing. The bearing assembly is configured to facilitate rotation of the rotatable shaft relative to the housing. As discussed in detail below, the rotatable shaft includes a recess extending along a portion of an axial extent (e.g., extent along an axial axis 52) of the rotatable shaft/disc assembly 12, in which the recess is formed by an inner surface of the rotatable shaft. In the illustrated embodiment, the axial axis 52 of the disc assembly 12 corresponds to the rotational axis of the disc blade 34. Furthermore, the rotatable shaft includes a first engagement feature formed on the inner surface of the rotatable shaft. The rotatable shaft also includes a key disposed about the recess. The key is configured to engage the opening of the disc blade to block rotation of the disc blade relative to the rotatable shaft, thereby non-rotatably coupling the disc blade and the rotatable shaft. As discussed in detail below, the key and the opening of the disc blade may have any suitable shape(s) suitable for blocking rotation of the disc blade relative to the shaft (e.g., polygonal, elliptical, star shaped, etc.).

In addition, the disc assembly 12 includes a fastener 54 having a shaft configured to extend through the opening of the disc blade 34 and to engage the recess of the rotatable shaft of the mounting assembly 48. The shaft has a second engagement feature configured to engage the first engagement feature to couple the disc blade 34 to the rotatable shaft. For example, in certain embodiments, the first engagement feature includes threads, and the second engagement feature includes threads. The threads of the fastener 54 (e.g., bolt) may be engaged with the threads of the rotatable shaft via rotation of the fastener 54 along a circumferential axis 56, thereby coupling the disc blade 34 to the rotatable shaft of the mounting assembly 48. Furthermore, due to the engagement of the key of the rotatable shaft with the opening in the disc blade 34, the disc blade 34 is non-rotatably coupled to the rotatable shaft of the mounting assembly 48.

A radial extent of the disc blade 34 (e.g., extent of the disc blade 34 along a radial axis 58) may be particularly selected based on the application (e.g., tillage, trench formation, etc.), the soil conditions, the type of soil, the expected speed of the agricultural implement, other suitable factor(s), or a combination thereof. Furthermore, the shape and configuration of the disc blade (e.g., concavity, smooth/notched/fluted, etc.) may also be selected based on the application (e.g., tillage, trench formation, etc.), the soil conditions, the type of soil, the expected speed of the agricultural implement, other suitable factor(s), or a combination thereof. In the illustrated embodiment, the disc blade 34 is formed from steel. However, in other embodiments, the disc blade may be formed from any other suitable material(s) (e.g., aluminum, a polymeric material, a composite material, etc.).

During operation of the agricultural implement, the disc blade 34 engages the soil. Movement of the agricultural implement along the direction of travel and friction between the disc blade 34 and the soil urges the disc blade to rotate. Because the disc blade 34 is non-rotatably coupled to the rotatable shaft and the rotatable shaft is configured to rotate relative to the housing 50 of the mounting assembly 48, the disc blade 34 may rotate during operation of the agricultural implement. Furthermore, because the disc blade is coupled to the mounting assembly with a single fastener, the process of replacing the disc blade may be performed significantly faster than replacing a disc blade that is coupled to a mounting assembly with multiple fasteners disposed about an axis of rotation of the disc blade, thereby increasing the efficiency of agricultural (e.g., tillage) operations.

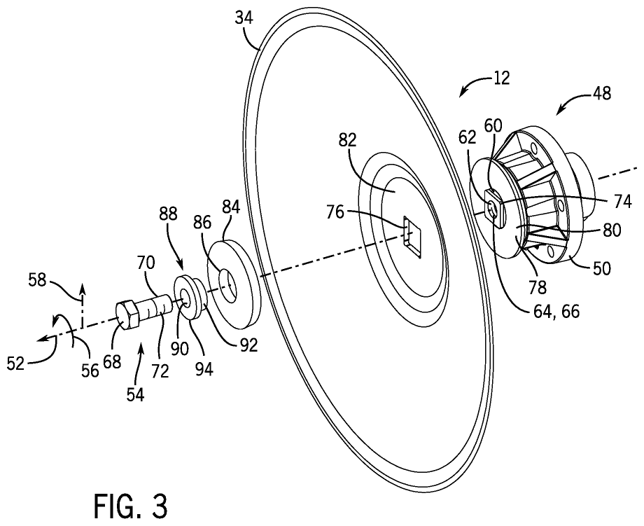

FIG. 3 is an exploded view of the disc assembly 12 of FIG. 2. As previously discussed, the mounting assembly 48 includes a housing 50 and a rotatable shaft 60 disposed within the housing. The rotatable shaft 60 is configured to rotate relative to the housing 50. For example, in certain embodiments, a bearing assembly may be disposed between the rotatable shaft and the housing, in which the bearing assembly is configured to facilitate rotation of the rotatable shaft relative to the housing. In the illustrated embodiment, the rotatable shaft 60 is formed from a single piece of material (e.g., steel, aluminum, etc.). However, in other embodiments, the rotatable shaft may be formed from multiple pieces of material coupled to one another.

As illustrated, the rotatable shaft 60 includes a recess 62 configured to receive the fastener 54. As discussed in detail below, the recess 62 extends along a portion of the axial extent of the rotatable shaft 60 (e.g., extent of the rotatable shaft 60 along the axial axis 52 of the disc assembly 12). As illustrated, the axial extent of the recess 62 is aligned with the axial axis 52 of the disc assembly 12, which in the illustrated embodiment, corresponds to the rotational axis of the disc blade 34. In addition, the recess 62 is formed by an inner surface 64 of the rotatable shaft 60, and the rotatable shaft 60 includes a first engagement feature 66 formed on the inner surface 64. In the illustrated embodiment, the first engagement feature 66 includes threads formed on the inner surface 64 of the rotatable shaft 60. Furthermore, the fastener 54 includes a head 68 and a shaft 70 extending from the head 68. The shaft 70 of the fastener 54 is configured to engage the recess 62 of the rotatable shaft 60. In addition, the shaft 70 has a second engagement feature 72 configured to engage the first engagement feature 66. In the illustrated embodiment, the second engagement feature 72 includes threads formed on an outer surface of the fastener shaft 70. The threads of the fastener shaft 70 are configured to engage the threads of the recess 62 via rotation of the fastener 54 relative to the rotatable shaft 60, thereby coupling the fastener 54 to the rotatable shaft 60.

While the engagement features include threads in the illustrated embodiment, in other embodiments, the engagement features may include any other suitable type(s) of engagement features (e.g., alone or in combination with the threads). For example, in certain embodiments, the first engagement feature may include a groove (e.g., extending along the circumferential axis) formed on the inner surface of the rotatable shaft, and the second engagement feature may include a protrusion (e.g., extending along the circumferential axis) formed on the outer surface of the fastener shaft (e.g., integrally formed with the fastener shaft, coupled to the fastener shaft, etc.). In such embodiments, engagement of the protrusion with the groove may couple the fastener to the rotatable shaft. Furthermore, in certain embodiments, the first engagement feature may include a protrusion (e.g., extending along the circumferential axis) formed on the inner surface of the rotatable shaft (e.g., integrally formed with the rotatable shaft, coupled to the rotatable shaft, etc.), and the second engagement feature may include a groove (e.g., extending along the circumferential axis) formed on the outer surface of the fastener shaft. In such embodiments, engagement of the protrusion with the groove may couple the fastener to the rotatable shaft.

In addition, the rotatable shaft 60 has a key 74 disposed about the recess 62. The key 74 is configured to engage an opening 76 of the disc blade 34 to block rotation of the disc blade 34 relative to the rotatable shaft 60. In the illustrated embodiment, the key 74 has a polygonal shape, and the opening 76 of the disc blade 34 has a corresponding polygonal shape. The polygonal shape may be a square, as illustrated, a triangle, a pentagon, a hexagon, or any other suitable polygonal shape. Furthermore, the key of the rotatable shaft and the opening of the disc blade may have any other shapes suitable for blocking rotation of the disc blade relative to the rotatable shaft while the key is engaged with the opening. For example, the key of the rotatable shaft may have an elliptical shape, a star shape, an irregular shape, or another suitable shape, and the opening of the disc blade may have a corresponding shape. The shape of the key and the shape of the disc blade opening may be the same as one another, or the key and the disc blade opening may have different shapes that enable the key to engage the opening and to block rotation of the disc blade relative to the rotatable shaft.

In the illustrated embodiment, the mounting assembly 48 includes a backing plate 78 engaged with the rotatable shaft 60. As illustrated, the backing plate 78 is disposed about the key 74, and the backing plate 78 has a substantially flat contact surface 80. The substantially flat contact surface 80 of the backing plate 78 is configured to interface with a corresponding substantially flat contact surface 82 of the disc blade 34. Because the contact surface 80 of the backing plate 78 is substantially flat, the cost of manufacturing the mounting assembly may be reduced (e.g., as compared to a mounting assembly having a curved mounting plate). In addition, the substantially flat contact surface of the backing plate may enable the mounting assembly to receive disc blades configured to be mounted in gangs, thereby increasing the variety of disc blades that may be coupled to the mounting assembly. While the backing plate 78 and the disc blade 34 have corresponding substantially flat surfaces in the illustrated embodiment, in other embodiments, the surface of the backing plate may have another suitable shape (e.g., curved, etc.), and the corresponding surface of the disc blade may have a similar/complementary shape. Furthermore, while the backing plate 78 directly contacts the disc blade 34 in the illustrated embodiment, in other embodiments, one or more elements (e.g., gasket(s), washer(s), etc.) may be disposed between the backing plate 78 and the disc blade 34. In addition, while the backing plate 78 and the rotatable shaft 60 are separate elements in the illustrated embodiment, in other embodiments, the rotatable shaft and the backing plate may be integrally formed (e.g., from a single piece of material).

In the illustrated embodiment, the disc assembly 12 includes a disc blade support 84 having an opening 86 configured to receive the shaft 70 of the fastener 54. As illustrated, the disc blade support 84 is disposed between the head 68 of the fastener 54 and the disc blade 34. In addition, the disc assembly 12 includes a bushing 88 having an opening 90 configured to receive the shaft 70 of the fastener 54. A first portion 92 of the bushing 88 is configured to be disposed within the opening 86 of the disc blade support 84, and a second portion 94 of the bushing 88 is configured to be disposed between the head 68 of the fastener 54 and the disc blade support 84. The bushing 88 is configured to distribute the load applied by the head 68 of the fastener 54 over a larger area of the disc blade support 84, and the disc blade support 84 is configured to distribute the load applied by the bushing 88 over a larger area of the disc blade 34. While the disc assembly 12 includes the disc blade support 84 and the bushing 88 in the illustrated embodiment, in other embodiments, at least one of the disc blade support or the bushing may be omitted. Furthermore, in certain embodiments, the rotatable shaft may extend through the disc blade support and/or the bushing.

To couple the disc blade 34 to the mounting assembly 48, the opening 76 of the disc blade 34 is aligned with the key 74. In addition, the disc blade 34 is rotated about the axial axis 52 to an orientation that facilitates engagement of the key 74 with the opening 76. The disc blade 34 is then moved toward the mounting assembly 48 until the key 74 engages the opening 76 of the disc blade 34 and the disc blade 34 interfaces with the backing plate 78. For example, as previously discussed, the disc blade 34 (e.g., the substantially flat contact surface 82 of the disc blade 34) may directly contact the backing plate 78 (e.g., the substantially flat contact surface 80 of the backing plate 78), or the disc blade 34 and the backing plate 78 may engage element(s) (e.g., washer(s), gasket(s), etc.) disposed between the disc blade 34 and the backing plate 78. Next, the bushing 88 is engaged with the disc blade support 84, and the shaft 70 of the fastener 54 is disposed through the opening 90 of the bushing 88. The shaft 70 of the fastener 54 is then disposed through the opening 76 of the disc blade 34, and the second engagement feature 72 of the fastener shaft 70 is engaged with the first engagement feature 66 of the rotatable shaft 60. Accordingly, movement of the disc blade 34 away from the housing 50 along the axial axis 52 is blocked by the head 68 of the fastener 54, the bushing 88, and the disc blade support 84, and movement of the disc blade 34 toward the housing 50 along the axial axis 52 is blocked by the backing plate 78. In addition, rotation of the disc blade 34 relative to the rotatable shaft 60 is blocked by the interface between the key 74 and the opening 76 of the disc blade 34.

During operation of the agricultural implement, the disc blade 34 engages the soil. Movement of the agricultural implement along the direction of travel and friction between the disc blade 34 and the soil urges the disc blade 34 and the rotatable shaft 60 to rotate. Because the disc blade 34 is non-rotatably coupled to the rotatable shaft 60 and the rotatable shaft is configured to rotate relative to the housing 50 of the mounting assembly 48, the disc blade 34 may rotate during operation of the agricultural implement. Furthermore, because the disc blade is coupled to the mounting assembly with a single fastener, the process of replacing the disc blade may be performed significantly faster than replacing a disc blade that is coupled to a mounting assembly with multiple fasteners disposed about an axis of rotation of the disc blade, thereby increasing the efficiency of agricultural (e.g., tillage) operations.

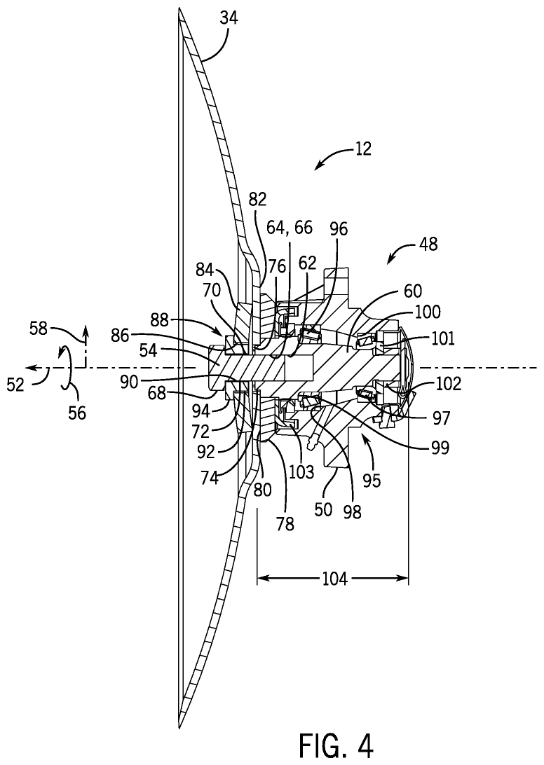

FIG. 4 is a cross-sectional view of the disc assembly 12 of FIG. 2. In the illustrated embodiment, the mounting assembly 48 includes a bearing assembly 95 disposed between the rotatable shaft 60 and the housing 50. The bearing assembly 95 is configured to facilitate rotation of the rotatable shaft 60 relative to the housing 50. In the illustrated embodiment, the bearing assembly 95 includes a first bearing 96 and a second bearing 97. As illustrated, the first bearing 96 is positioned closer to the disc blade 34 along the axial axis 52 than the second bearing 97. In the illustrated embodiment, the first bearing 96 and the second bearing 97 are roller bearings. However, in other embodiments, at least one of the bearings may be another suitable type of bearing, such as a ball bearing. Furthermore, while the bearing assembly 95 includes two bearings in the illustrated embodiment, in other embodiments, the bearing assembly may include more or fewer bearings (e.g., 0, 1, 3, 4, 5, 6, or more). In addition, the mounting assembly may include other suitable device(s) disposed between the rotatable shaft and the housing to facilitate rotation of the rotatable shaft (e.g., alone or in combination with the bearing(s)), such as bushing(s).

In the illustrated embodiment, movement of the rotatable shaft 60 along the axial axis 52 toward an end of the housing 50 facing away from the disc blade 34 is blocked by the first bearing 96. For example, movement of the first bearing 96 toward the end of the housing 50 facing away from the disc blade 34 is blocked by contact between the first bearing 96 (e.g., an outer race of the first bearing 96) and a shoulder 98 of the housing 50, and movement of the rotatable shaft 60 toward the end of the housing 50 facing away from the disc blade 34 is blocked by contact between the first bearing 96 (e.g., an inner race of the first bearing 96) and a shoulder 99 of the rotatable shaft 60. In addition, movement of the rotatable shaft 60 along the axial axis 52 toward an end of the housing 50 facing toward the disc blade 34 is blocked by the second bearing 97. For example, movement of the second bearing 97 toward the end of the housing 50 facing toward the disc blade 34 is blocked by contact between the second bearing 97 (e.g., an outer race of the second bearing 97) and a shoulder 100 of the housing 50, movement of a retaining disc 101 toward the end of the housing 50 facing toward the disc blade 34 is blocked by contact between the retaining disc 101 and the second bearing 97 (e.g., an inner race of the second bearing 97), and movement of the rotatable shaft 60 toward the end of the housing 50 facing toward the disc blade 34 is blocked by contact between a fastener 102, which is coupled to the rotatable shaft 60, and the retaining disc 101. In the illustrated embodiment, the fastener 102 includes a nut coupled to the rotatable shaft 60 by a threaded connection, in which rotation of the nut is blocked by a pin extending through the rotatable shaft. However, in other embodiments, the fastener may include any other suitable type of fastening element(s) (e.g., alone or in combination with the nut), such as a pin, a clip, other suitable type(s) of fastener(s), or a combination thereof.

During assembly of the mounting assembly 48, the rotatable shaft 60 may be inserted into the housing 50 via a first opening in the housing 50 at the end facing toward the disc blade 34. The rotatable shaft 60 may then be moved along the axial axis 52 until the shoulder 99 of the rotatable shaft 60 contacts the first bearing 96. Next, the retaining disc 101 may be inserted into the housing 50 via a second opening in the housing 50 at the end facing away from the disc blade 34. The retaining disc 101 may then be moved along the axial axis 52 until the retaining disc 101 contacts the second bearing 97, and the fastener 102 may be inserted into the housing 50 via the second opening and coupled to the rotatable shaft 60. In certain embodiments, an end cap may be coupled to the housing to cover the second opening, thereby substantially blocking dirt and/or debris from entering the bearing assembly (e.g., from becoming mixed with the lubricant within the bearing assembly). While the rotatable shaft 60 is rotatably coupled to the housing 50 via the structures disclosed above in the illustrated embodiment, in other embodiments, the rotatable shaft may be coupled to the housing by any other suitable structure(s) and/or assembly/assemblies, such as via the arrangement disclosed below.

Furthermore, in the illustrated embodiment, the mounting assembly 48 includes a seal 103 (e.g., labyrinth seal, etc.) configured to substantially block dirt and/or debris from entering the bearing assembly via the first opening. While the mounting assembly includes a single seal in the illustrated embodiment, in other embodiments, the mounting assembly may include more or fewer seals. For example, in certain embodiments, the illustrated seal may be omitted, and/or the mounting assembly may include a seal coupled to the backing plate and configured to contact the housing, as discussed in detail below.

In the illustrated embodiment, the recess 62 of the rotatable shaft 60 extends along a portion of an axial extent 104 of the rotatable shaft (e.g., extent of the rotatable shaft 60 along the axial axis 52). Accordingly, only one end of the recess 62 is open, thereby reducing an amount of dirt/debris that may enter the recess (e.g., as compared to a recess that extends along an entire extent of the rotatable shaft and has two openings, i.e., one opening at each end of the recess). As previously discussed, the first engagement feature 66 (e.g., threads) of the recess 62 is configured to engage the second engagement feature (e.g., threads) of the shaft 70 of the fastener 54 while the shaft 70 of the fastener 54 is disposed within the recess 62, thereby capturing the disc blade 34 between the head 68 of the fastener 54 and the backing plate 78. While the recess extends along a portion of the axial extent of the rotatable shaft in the illustrated embodiment, in other embodiments, the recess may extend along the entire axial extent of the rotatable shaft.

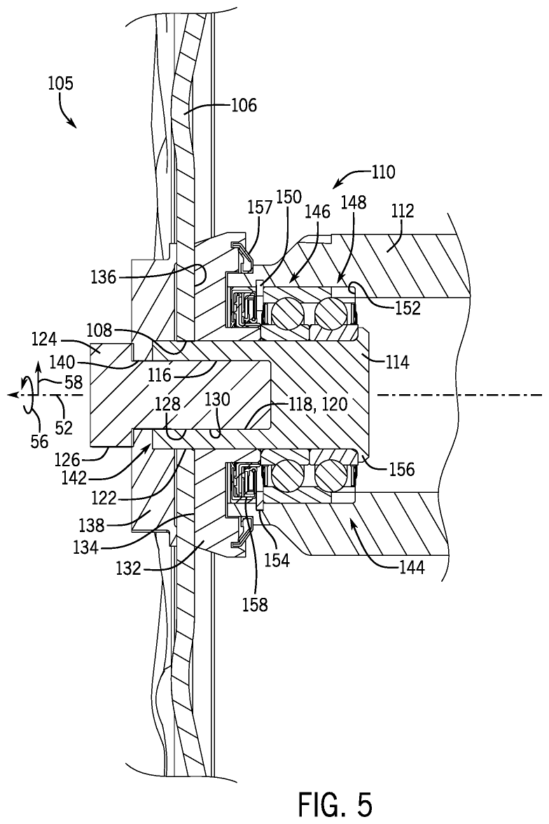

FIG. 5 is a cross-sectional view of a portion of another embodiment of a disc assembly 105 that may be employed within the agricultural implement of FIG. 1. In the illustrated embodiment, the disc assembly 105 includes a disc blade 106 having an opening 108. The disc assembly 105 also includes a mounting assembly 110 having a housing 112 and a rotatable shaft 114 disposed within the housing 112. As previously discussed with regard to the embodiment of FIGS. 2-4, the rotatable shaft 114 is configured to rotate relative to the housing 112. In the illustrated embodiment, the rotatable shaft 114 is formed from a single piece of material (e.g., steel, aluminum, etc.). However, in other embodiments, the rotatable shaft may be formed from multiple pieces of material coupled to one another.

As illustrated, the rotatable shaft 114 has a recess 116 extending along a portion of the axial extent of the rotatable shaft 114 (e.g., extent of the rotatable shaft 114 along the axial axis 52 of the disc assembly 105). In addition, the recess 116 is formed by an inner surface 118 of the rotatable shaft 114, and the rotatable shaft 114 includes a first engagement feature 120 formed on the inner surface 118. As previously discussed with regard to the embodiment of FIGS. 2-4, the first engagement feature 120 may include threads formed on the inner surface 118 of the rotatable shaft 114. Furthermore, the rotatable shaft 114 includes a key 122 disposed about the recess 116, and the key 122 is configured to engage the opening 108 of the disc blade 106 to block rotation of the disc blade 106 relative to the rotatable shaft 114. For example, as previously discussed with regard to the embodiment of FIGS. 2-4, the key 122 may have a polygonal shape, and the opening 108 of the disc blade 106 may have a corresponding polygonal shape. While the recess extends along a portion of the axial extent of the rotatable shaft in the illustrated embodiment, in other embodiments, the recess may extend along the entire axial extent of the rotatable shaft.

Furthermore, the disc assembly 105 includes a fastener 124 having a head 126 and a shaft 128 extending from the head 126. The shaft 128 of the fastener 124 is configured to extend through the opening 108 of the disc blade 106 and to engage the recess 116 of the rotatable shaft 114. In addition, the shaft 128 has a second engagement feature 130 configured to engage the first engagement feature 120 of the rotatable shaft 114 to couple the disc blade 106 to the rotatable shaft 114. As previously discussed with regard to the embodiment of FIGS. 2-4, the second engagement feature 130 may include threads formed on an outer surface of the fastener shaft 128. In such embodiments, the threads of the fastener shaft 128 are configured to engage corresponding threads of the recess 116 via rotation of the fastener 124 relative to the rotatable shaft 114, thereby coupling the fastener 124 to the rotatable shaft 114.

In the illustrated embodiment, the mounting assembly 110 includes a backing plate 132 engaged with the rotatable shaft 114. As illustrated, the backing plate 132 is disposed about the key 122, and the backing plate 132 has a substantially flat contact surface 134. The substantially flat contact surface 134 of the backing plate 132 is configured to interface with a corresponding substantially flat contact surface 136 of the disc blade 106. While the backing plate 132 and the disc blade 106 have corresponding substantially flat surfaces in the illustrated embodiment, in other embodiments, the surface of the backing plate may have another suitable shape (e.g., curved, etc.), and the corresponding surface of the disc blade may have a similar/complementary shape. Furthermore, while the backing plate 132 directly contacts the disc blade 106 in the illustrated embodiment, in other embodiments, one or more elements (e.g., gasket(s), washer(s), etc.) may be disposed between the backing plate 132 and the disc blade 106. In addition, while the backing plate 132 and the rotatable shaft 114 are separate elements in the illustrated embodiment, in other embodiments, the rotatable shaft and the backing plate may be integrally formed (e.g., from a single piece of material).

In the illustrated embodiment, the disc assembly 105 includes a disc blade support 138 having an opening 140 configured to receive the shaft 128 of the fastener 124. As illustrated, the disc blade support 138 is disposed between the head 126 of the fastener 124 and the disc blade 106. In the illustrated embodiment, the disc blade support 138 has a recess 142 configured to receive an end of the rotatable shaft 114. However, in other embodiments, the recess may be omitted, and the rotatable shaft may extend to/proximate to the disc blade support (e.g., as disclosed above with reference to the embodiment of FIGS. 2-4) or through the disc blade support. Furthermore, in certain embodiments, the disc blade support may be omitted, and/or the disc assembly may include a bushing, such as the bushing disclosed above with reference to the embodiment of FIGS. 2-4.

To couple the disc blade 106 to the mounting assembly 110, the opening 108 of the disc blade 106 is aligned with the key 122. In addition, the disc blade 106 is rotated about the axial axis 52 to an orientation that facilitates engagement of the key 122 with the opening 108. The disc blade 106 is then moved toward the mounting assembly 110 until the key 122 engages the opening 108 of the disc blade 106 and the disc blade 106 interfaces with the backing plate 132. Next, the disc blade support 138 is engaged with the rotatable shaft 114, such that the disc blade support 138 interfaces with the disc blade 106. The shaft 128 of the fastener 124 is then disposed through the opening 140 of the disc blade support 138 and the opening 108 of the disc blade 106, and the second engagement feature 130 of the fastener shaft 128 is engaged with the first engagement feature 120 of the rotatable shaft 114. Accordingly, movement of the disc blade 106 away from the housing 112 along the axial axis 52 is blocked by the head 126 of the fastener 124 and the disc blade support 138, and movement of the disc blade 106 toward the housing 112 along the axial axis 52 is blocked by the backing plate 132. In addition, rotation of the disc blade 106 relative to the rotatable shaft 114 is blocked by the interface between the key 122 and the opening 108 of the disc blade 106.

In the illustrated embodiment, the mounting assembly 110 includes a bearing assembly 144 disposed between the rotatable shaft 114 and the housing 112. The bearing assembly 144 is configured to facilitate rotation of the rotatable shaft 114 relative to the housing 112. In the illustrated embodiment, the bearing assembly 144 includes a first bearing 146 and a second bearing 148 (e.g., having a common outer race or separate outer races, and/or having a common inner race or separate inner races). As illustrated, the first bearing 146 is positioned closer to the disc blade 106 along the axial axis 52 than the second bearing 148. In the illustrated embodiment, the first bearing 146 and the second bearing 148 are ball bearings. However, in other embodiments, at least one of the bearings may be another suitable type of bearing, such as a roller bearing. Furthermore, while the bearing assembly 144 includes two bearings in the illustrated embodiment, in other embodiments, the bearing assembly may include more or fewer bearings (e.g., 0, 1, 3, 4, 5, 6, or more). In addition, the mounting assembly may include other suitable device(s) disposed between the rotatable shaft and the housing to facilitate rotation of the rotatable shaft (e.g., alone or in combination with the bearing(s)), such as bushing(s).

In the illustrated embodiment, the bearing assembly 144 is retained within the housing 112 by a snap ring 150. As illustrated, the housing 112 has a shoulder 152 configured to engage the bearing assembly 144 (e.g., an outer race of the bearing assembly) to block movement of the bearing assembly 144 away from the disc blade 106 along the axial axis 52. In addition, the housing 112 has a recess 154 configured to receive the snap ring 150. During assembly of the mounting assembly 110, the bearing assembly 144 may be disposed within the housing 112 and moved along the axial axis 52 until the bearing assembly 144 engages the shoulder 152. The snap ring 150 may then be engaged with the recess 154, thereby blocking movement of the bearing assembly 144 away from the shoulder 152 along the axial axis 52. While the bearing assembly 144 is retained within the housing 112 by the snap ring 150 and the shoulder 152 in the illustrated embodiment, in other embodiments, the bearing assembly may be retained within the housing by any other suitable structure/assembly (e.g., two snap rings, one or more fasteners, etc.).

In the illustrated embodiment, movement of the rotatable shaft 114 out of the housing 112 along the axial axis 52 is blocked by contact between a protrusion 156 of the rotatable shaft 114 and the bearing assembly 144 (e.g., an inner race of the second bearing 148). In addition, movement of the rotatable shaft 114 into the housing 112 is blocked by contact between the backing plate 132 and the bearing assembly 144 (e.g., an inner race of the first bearing 146). For example, movement of the backing plate 132 toward the housing 112 is blocked by the bearing assembly 144, movement of the disc blade 106 toward the housing 112 is blocked by the backing plate 132, movement of the disc blade support 138 toward the housing 112 is blocked by the disc blade 106, movement of the fastener 124 toward the housing 112 is blocked by the disc blade support 138, and movement of the rotatable shaft 114 into the housing 112 is blocked by the fastener 124. During assembly of the mounting assembly 110, the rotatable shaft 114 may be inserted into the housing 112 via an opening in the housing 112 and moved along the axial axis 52 until the protrusion 156 of the rotatable shaft 114 contacts the bearing assembly 144. Alternatively, the rotatable shaft 114 may be engaged with the bearing assembly 144 before the bearing assembly is disposed within the housing, and the bearing assembly may then be coupled to the housing 112, as discussed above. Next, the backing plate 132 may be engaged with the rotatable shaft 114. The disc blade 106 may then be coupled to the mounting assembly 110, as discussed above, thereby rotatably coupling the rotatable shaft 114 to the housing 112. While the rotatable shaft 114 is rotatably coupled to the housing 112 via the structures disclosed above in the illustrated embodiment, in other embodiments, the rotatable shaft may be coupled to the housing by any other suitable structure(s) and/or assembly/assemblies, such as via the arrangement disclosed above with reference to the embodiment of FIGS. 2-4.

In the illustrated embodiment, the backing plate 132 includes a seal 157 (e.g., labyrinth seal, etc.) configured to contact the housing 112 to substantially block dirt and/or debris from entering the bearing assembly (e.g., from becoming mixed with the lubricant within the bearing assembly). Furthermore, in the illustrated embodiment, the mounting assembly 110 includes another seal 158 (e.g., labyrinth seal, etc.) disposed within the housing 112 and configured to substantially block dirt and/or debris from entering the bearing assembly (e.g., from becoming mixed with the lubricant within the bearing assembly). While the mounting assembly includes two seals in the illustrated embodiment, in other embodiments, the mounting assembly may include more or fewer seals. For example, in certain embodiments, at least one of the illustrated seals may be omitted.

Any of the variations disclosed above with reference to the embodiment of FIGS. 2-4 may apply to the illustrated embodiment. For example, any of the variations in key shape, opening shape, and engagement feature type disclosed above with reference to the embodiment of FIGS. 2-4 may apply to the illustrated embodiment. Furthermore, any of the features disclosed in the illustrated embodiment may be employed within the embodiment of FIGS. 2-4, and any of the features disclosed in the embodiment of FIGS. 2-4 may be employed within the illustrated embodiment. For example, the illustrated embodiment may include the bearing assembly of the embodiment of FIGS. 2-4. Furthermore, the disc blade support of the illustrated embodiment may be employed within the embodiment of FIGS. 2-4 (e.g., the rotatable shaft may engage a recess of the disc blade support).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A disc assembly for an agricultural implement, comprising:
a mounting assembly comprising a housing and a rotatable shaft disposed within the housing, wherein the rotatable shaft is configured to rotate relative to the housing, and the rotatable shaft comprises:
a recess extending along a portion of an axial extent of the rotatable shaft, wherein the recess is formed by an inner surface of the rotatable shaft;
a first engagement feature formed on the inner surface; and
a key disposed about the recess, wherein the key is configured to engage an opening of a disc blade to block rotation of the disc blade relative to the rotatable shaft; and
a fastener having a shaft configured to extend through the opening of the disc blade and to engage the recess of the rotatable shaft, wherein the shaft of the fastener has a second engagement feature configured to engage the first engagement feature to couple the disc blade to the rotatable shaft.

2. The disc assembly of claim 1, wherein the mounting assembly comprises a backing plate having a substantially flat contact surface disposed about the key, and the substantially flat contact surface of the backing plate is configured to interface with a corresponding substantially flat contact surface of the disc blade.

3. The disc assembly of claim 1, comprising a disc blade support having an opening configured to receive the shaft of the fastener, wherein the disc blade support is configured to be disposed between a head of the fastener and the disc blade.

4. The disc assembly of claim 3, comprising a bushing having an opening configured to receive the shaft of the fastener, wherein a first portion of the bushing is configured to be disposed within the opening of the disc blade support, and a second portion of the bushing is configured to be disposed between the head of the fastener and the disc blade support.

5. The disc assembly of claim 1, wherein the mounting assembly comprises a bearing assembly disposed between the rotatable shaft and the housing, and the bearing assembly is configured to facilitate rotation of the rotatable shaft relative to the housing.

6. The disc assembly of claim 5, comprising a snap ring configured to retain the bearing assembly within the housing.

7. The disc assembly of claim 1, wherein the first engagement feature comprises threads, and the second engagement feature comprises corresponding threads.

8. The disc assembly of claim 1, wherein the key has a polygonal shape.

9. A disc assembly for an agricultural implement, comprising:
a disc blade having an opening;
a mounting assembly comprising a housing and a rotatable shaft disposed within the housing, wherein the rotatable shaft is configured to rotate relative to the housing, and the rotatable shaft comprises:
a recess extending along at least a portion of an axial extent of the rotatable shaft, wherein the recess is formed by an inner surface of the rotatable shaft;
a first engagement feature formed on the inner surface; and
a key disposed about the recess, wherein the key is configured to engage the opening of the disc blade to block rotation of the disc blade relative to the rotatable shaft; and
a fastener having a shaft configured to extend through the opening of the disc blade and to engage the recess of the rotatable shaft, wherein the shaft of the fastener has a second engagement feature configured to engage the first engagement feature to couple the disc blade to the rotatable shaft.

10. The disc assembly of claim 9, wherein the mounting assembly comprises a backing plate having a substantially flat contact surface disposed about the key, the disc blade has a corresponding substantially flat contact surface, and the substantially flat contact surface of the backing plate is configured to interface with the corresponding substantially flat contact surface of the disc blade.

11. The disc assembly of claim 9, comprising a disc blade support having an opening configured to receive the shaft of the fastener, wherein the disc blade support is configured to be disposed between a head of the fastener and the disc blade.

12. The disc assembly of claim 11, comprising a bushing having an opening configured to receive the shaft of the fastener, wherein a first portion of the bushing is configured to be disposed within the opening of the disc blade support, and a second portion of the bushing is configured to be disposed between the head of the fastener and the disc blade support.

13. The disc assembly of claim 9, wherein the first engagement feature comprises threads, and the second engagement feature comprises corresponding threads.

14. The disc assembly of claim 9, wherein the rotatable shaft is formed from a single piece of material.

15. A disc assembly for an agricultural implement, comprising:
a mounting assembly comprising a housing and a rotatable shaft disposed within the housing, wherein the rotatable shaft is configured to rotate relative to the housing, and the rotatable shaft comprises:
a recess extending along a portion of an axial extent of the rotatable shaft, wherein the recess is formed by an inner surface of the rotatable shaft;
a first engagement feature formed on the inner surface of the recess; and
a key disposed about the recess, wherein the key is configured to engage an opening of a disc blade to block rotation of the disc blade relative to the rotatable shaft; and
a fastener having a head and a shaft extending from the head, wherein the shaft of the fastener is configured to extend through the opening of the disc blade and to engage the recess of the rotatable shaft, the shaft of the fastener has a second engagement feature configured to engage the first engagement feature to block removal of the shaft of the fastener from the recess, and the head is configured to block movement of the disc blade away from the rotatable shaft.

16. The disc assembly of claim 15, wherein the key has a polygonal shape.

17. The disc assembly of claim 15, wherein the rotatable shaft is formed from a single piece of material.

18. The disc assembly of claim 15, wherein the first engagement feature comprises threads, and the second engagement feature comprises corresponding threads.

19. The disc assembly of claim 15, wherein the mounting assembly comprises a backing plate having a substantially flat contact surface disposed about the key, and the substantially flat contact surface is configured to interface with a corresponding substantially flat contact surface of the disc blade.

20. The disc assembly of claim 15, wherein the mounting assembly comprises a bearing assembly disposed between the rotatable shaft and the housing, and the bearing assembly is configured to facilitate rotation of the rotatable shaft relative to the housing.
